(19) United States
(12) Patent Application Publication
(10) Pub. No.: US 2021/0397188 A1
(43) Pub. Date: Dec. 23, 2021

(54) MOVING BODY, CONTROL METHOD FOR MOVING BODY, AND PROGRAM

(71) Applicant: SONY CORPORATION, TOKYO (JP)

(72) Inventor: NAOYUKI SATO, TOKYO (JP)

(21) Appl. No.: 17/287,741

(22) PCT Filed: Oct. 29, 2019
(86) PCT No.: PCT/JP2019/042438

§ 371 Date: Apr. 22, 2021

(30) Foreign Application Priority Data
Nov. 1, 2018 (JP) 2018-206302

(51) Int. Cl. G05D 1/02; G05D 1/00; G06Q 10/08

(52) U.S. Cl. CPC G05D 1/0212; G05D 1/0274; G05D 2201/0216; G06Q 10/0832; G05D 1/0088

(57) ABSTRACT

A moving body capable of moving satisfactorily after going into a private space is provided. Autonomous traveling is performed using information from a sensor that recognizes an outer world. In a specific region, information regarding the specific region is acquired and the autonomous traveling is performed on the basis of the acquired information. For example, the information regarding the specific region includes map information on this specific region, unique rule information on this specific region, key information for decrypting encrypted map information on this specific region, or key information for entering the specific region. For example, when leaving the specific region, the information regarding the specific region is deleted and information on this specific region is prevented from leaking to the outside.

### TECHNICAL FIELD

The present technology relates to a moving body, a control method for the moving body, and a program, and in more detail, to a moving body and the like that move by going into a private space such as the premises of an apartment.

### BACKGROUND ART

Conventionally, moving bodies capable of autonomous traveling equipped with artificial intelligence, such as pet robots at home, transportation robots in factories and distribution warehouses, and home delivery robots, have been known (see, for example, Patent Document 1).

### CITATION LIST

### Patent Document

Patent Document 1: Japanese Patent Application Laid-Open No. 2003-340760

### SUMMARY OF THE INVENTION

### Problems to be Solved by the Invention

For example, in a case where it is assumed that a home delivery robot goes into the premises of an apartment and delivers a package to a delivery destination dwelling unit, the home delivery robot needs information regarding the apartment, such as a map and unique rules, in order to autonomously travel in the apartment, which is a private space.

An object of the present technology is to provide a moving body capable of moving satisfactorily after going into a private space.

### Solutions to Problems

The concept of the present technology is in

a moving body including:

a sensor that recognizes an outer world;

an autonomous traveling unit that autonomously travels using information from the sensor; and

an information acquisition unit that acquires information regarding a specific region, in which

the autonomous traveling unit autonomously travels in the specific region on the basis of the information regarding the specific region.

In the present technology, the autonomous traveling using the information from the sensor that recognizes the outer world is performed by the autonomous traveling unit. For example, the sensor may be designed to include at least one of a camera, a time-of-flight (ToF) sensor, a light detection and ranging or laser imaging detection and ranging (LIDAR) sensor, a global positioning system (GPS) sensor, a magnetic sensor, or a radio wave intensity sensor.

The information regarding the specific region is acquired by the information acquisition unit. Then, in the autonomous traveling unit, the autonomous traveling is performed in the specific region on the basis of this information regarding the specific region. For example, the information acquisition unit may be configured to receive the information regarding the specific region from a cloud. For example, the information regarding the specific region may be designed to include map information on this specific region, unique rule information on this specific region, key information for decrypting encrypted map information on this specific region, or key information for entering the specific region.

For example, an information storage unit that stores information, and an application switching control unit that switches an application stored in the information storage unit when entering the specific region from a first application for enabling autonomous traveling outside the specific region to a second application including the information regarding the specific region may be further provided.

In this case, for example, the application switching control unit may be configured to control such that, when switching the first application to the second application, predetermined information is passed from the first application to the second application. In this case, for example, the predetermined information may be designed to be passed from the first application to the second application via a shared area. For example, a cloud (a server connected via a computer network such as the Internet) may be designed to contain this shared area. Furthermore, in this case, for example, the predetermined information may be designed to include information regarding home delivery.

In addition, in this case, for example, the application switching control unit may be configured to switch the first application to the second application at a timing of acquisition of information prepared at an entrance of the specific region. Besides, in this case, for example, the application switching control unit may be configured to switch the first application to the second application at an application switching timing associated with map information.

As described above, in the present technology, autonomous traveling in the specific region is achieved on the basis of the information regarding this specific region. Therefore, moving after going into the specific region can be performed satisfactorily.

Note that, in the present technology, for example, an information deletion unit that deletes the information regarding the specific region when leaving the specific region may be further provided. This makes it possible to prevent information on the specific region from leaking to the outside.

### BRIEF DESCRIPTION OF DRAWINGS

FIG. 1 is a block diagram illustrating an outline of a home delivery system as an embodiment.

FIG. 2 is a diagram illustrating an example of an overview of a home delivery truck that has pulled up at a parking position.

FIG. 3 is a diagram illustrating an example of an overview of a home delivery robot.

FIG. 4 is a block diagram illustrating an example of a hardware configuration of the home delivery robot.

FIG. 5 is a diagram for explaining application switching.

FIG. 6 is a diagram for explaining information included in an apartment application.

FIG. 7 is a diagram illustrating an example of an entrance of an apartment.

FIG. 8 is a diagram illustrating an example of map information on an apartment.

FIG. 9 is a diagram illustrating an example of the home delivery robot downloading an apartment application and a home delivery company application from a cloud.

FIG. 10 is a diagram illustrating another example of the home delivery robot downloading an apartment application and a home delivery company application from a cloud.

FIG. 11 is a diagram for explaining a case where application switching is performed at a timing of acquisition of information prepared at an entrance of an apartment.

FIG. 12 is a flowchart illustrating an example of an application switching process procedure on a platform of the home delivery robot.

FIG. 13 is a diagram illustrating an example of general map information.

FIG. 14 is a flowchart illustrating another example of the application switching process procedure on the platform of the home delivery robot.

### MODE FOR CARRYING OUT THE INVENTION

Modes for carrying out the invention (hereinafter, referred to as “embodiments”) will be described below. Note that the description will be given in the following order.

1. Embodiments

2. Modifications

### 1. Embodiments

[Configuration Example of Home Delivery System]

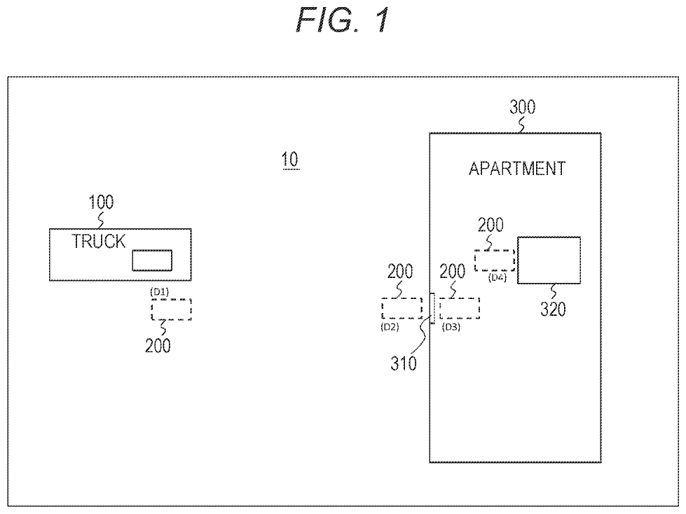

FIG. 1 illustrates an outline of a home delivery system 10 as an embodiment. A home delivery truck 100 of a home delivery company is driven by a driver, and travels to the neighborhood of an apartment 300, which is the destination of home delivery, to park there with a home delivery robot 200 as a moving body loaded together with a package (not illustrated). This parking position is at, for example, a parking space on a road or a site of the apartment.

At this parking position, the home delivery robot 200 gets off the home delivery truck 100 (see a position D1). In this case, the home delivery robot 200 accommodates a package, which is a target to be delivered to a home. This accommodation of the package may be completed either before getting off the home delivery truck 200 or after getting off the home delivery truck 200. Furthermore, this accommodation of the package is automatically completed by the home delivery robot 200 or completed by the driver.

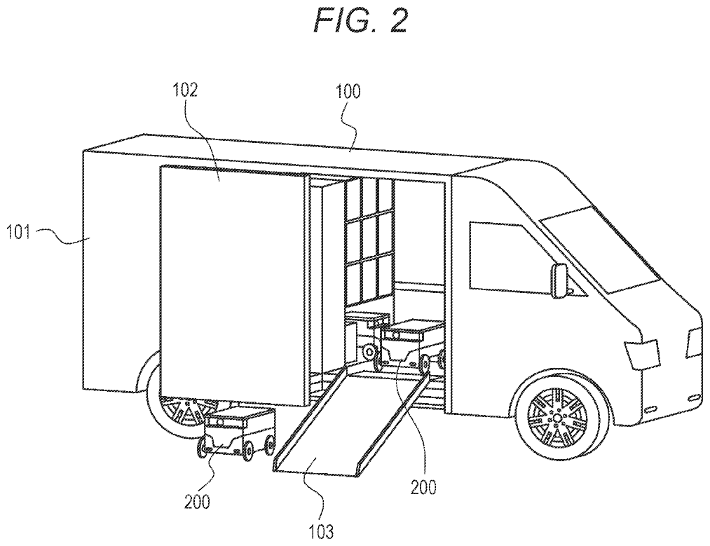

FIG. 2 illustrates an example of an overview of the home delivery truck 100 that has pulled up at the parking position. This example illustrates a state in which a side door 102 provided in a part of a side panel 101 is kept open, and the home delivery robots 200 are contained inside the side door 102 together with packages, which are targets to be delivered to homes. Furthermore, in this example, a ladder rail 103 for letting the home delivery robot 200 off is installed in the portion of the open side door 101.

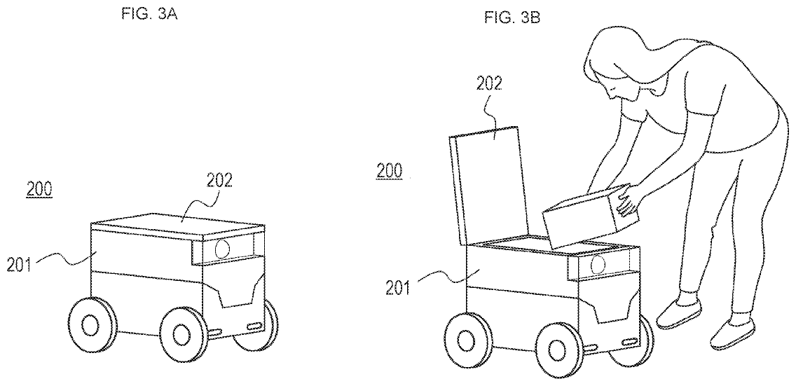

FIG. 3(a) illustrates an example of an overview of the home delivery robot 200. This home delivery robot 200 has a box-shaped main body 201 having a substantially rectangular parallelepiped shape, and is configured to autonomously travel with four wheels arranged below the main body 201. At an upper part of the main body 201, there is a lid 202 for opening and closing an accommodation space for a package inside the main body 201. This lid 202 can be opened as illustrated in FIG. 3(b) by, for example, a person (recipient) at the delivery destination inputting a unique personal identification number, and the package can be taken out from the accommodation space.

The home delivery robot 200 includes a sensor that recognizes the outer world and, for example, is configured such that the home delivery robot 200 can autonomously travel to the destination on the basis of map information in addition to using information from this sensor.

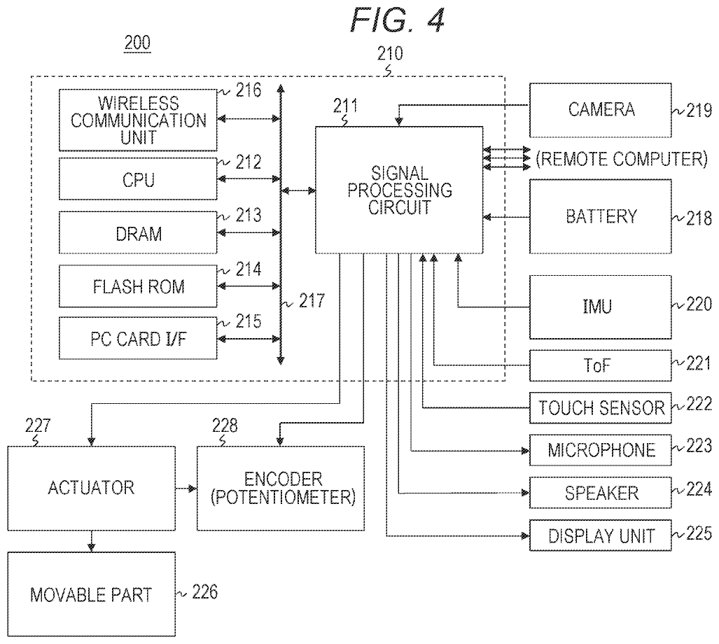

FIG. 4 illustrates an example of a hardware configuration of the home delivery robot 200. The home delivery robot 200 includes a control unit 210 and a battery 218 as a power source for this home delivery robot 200. The control unit 210 is formed by connecting, for example, a central processing unit (CPU) 212, a dynamic random access memory (DRAM) 213, a flash read only memory (ROM) 214, a personal computer (PC) card interface (I/F) 215, a wireless communication unit 216, and a signal processing circuit 211 to each other via an internal bus 217.

Furthermore, the home delivery robot 200 includes, as an activation mechanism for enabling actions such as movements and gestures, movable parts 226 such as joint parts of an arm portion and a leg portion and wheels, and an actuator 227 for driving these movable parts.

The home delivery robot 200 further includes, as sensors (hereinafter referred to as “inner world sensors”) for acquiring information on the moving distance, moving speed, moving direction, posture, and the like, an inertial measurement unit (IMU) 220 for detecting the orientation and the acceleration of motion of the home delivery robot 200, and an encoder (or potentiometer) 228 that detects the amount of drive of the actuator 227. Note that, in addition to these members, an acceleration sensor, an angular velocity sensor, and the like can be used as the inner world sensors.

The home delivery robot 200 further includes, as sensors (hereinafter referred to as “outer world sensors”) that acquire information on the terrain around the home delivery robot 200, the distance and direction to an object present around the home delivery robot 200, and the like, a camera 219 that images the external situation, and a time-of-flight (ToF) sensor 221 that measures the distance to an object present in a specific direction with respect to the home delivery robot 200. Note that, in addition to these members, a light detection and ranging or laser imaging detection and ranging (LIDAR) sensor, a global positioning system (GPS) sensor, a magnetic sensor, a measuring unit (hereinafter referred to as a radio wave intensity sensor) for the intensity of a radio wave in the wireless communication unit 216, such as Bluetooth (registered trademark) and Wi-Fi (registered trademark), and the like can be used as the outer world sensors.

Additionally, the home delivery robot 200 includes a touch sensor 222 for detecting physical pressure received from the outside, a microphone 223 for collecting external sound, a speaker 224 for outputting sound or the like to the surroundings, and a display unit 225 for displaying various kinds of information to a user or the like.

In the above configuration, various sensors such as the camera 219, the IMU 220, the touch sensor 222, the ToF sensor 221, the microphone 223, the speaker 224, and the encoder (or the potentiometer) 228, the display unit 225, the actuator 227, the camera 219, and the battery 218 are each connected to the signal processing circuit 211 of the control unit 210.

The signal processing circuit 211 sequentially captures sensor information, image information, and sound information supplied from the various sensors described above. Then, the signal processing circuit 211 sequentially saves these supplied pieces of information at predetermined positions in the DRAM 213 via the internal bus 217. Furthermore, the signal processing circuit 211 sequentially captures battery remaining amount information representing the battery remaining amount, which has been supplied from the battery 218 together with the above information, and saves the captured battery remaining amount information at a predetermined position in the DRAM 213.

Each of the sensor information, the image information, the sound information, and the battery remaining amount information saved in the DRAM 213 in this manner is used when the CPU 212 controls the action of the home delivery robot 200, and is also transmitted to an external server or the like via the wireless communication unit 216 as necessary. Note that the wireless communication unit 216 can be a communication unit for communicating with an external server or the like via a predetermined network such as a wireless local area network (LAN) or a moving body communication network, in addition to Bluetooth (registered trademark), Wi-Fi (registered trademark), and the like.

For example, the CPU 212 reads out a control program saved in the flash ROM 214 at the initial stage when the power of the home delivery robot 200 is turned on, and saves the read-out control program in the DRAM 213.

Furthermore, as described above, the CPU 212 determines the situations of the own robot and its surroundings, the presence or absence of an instruction or an approach from the user, and the like, on the basis of each of the sensor information, the image information, the sound information, and the battery remaining amount information sequentially saved in the DRAM 213 from the signal processing circuit 211.

Moreover, the CPU 212 executes self-position estimation and a variety of actions, using map data saved in the DRAM 213 or the like, or map data and various kinds of information acquired from an external server or the like via the wireless communication unit 216.

Then, the CPU 212 designates the subsequent behavior on the basis of the result of the above-mentioned determination, the estimated self-position, the control program saved in the DRAM 213, and the like, and also executes various behaviors such as movements and gestures by driving the necessary actuator 227 on the basis of the designation result.

At that time, the CPU 212 generates sound data as necessary. Then, by giving this sound data to the speaker 224 as a sound signal via the signal processing circuit 211, a sound based on the given sound signal is caused to output to the outside, or various kinds of information are caused to be displayed on the display unit 225.

In this manner, the home delivery robot 200 is configured such that the home delivery robot 200 can behave autonomously in response to the situations of the home delivery robot 200 and its surroundings, and an instruction and an approach from the user.

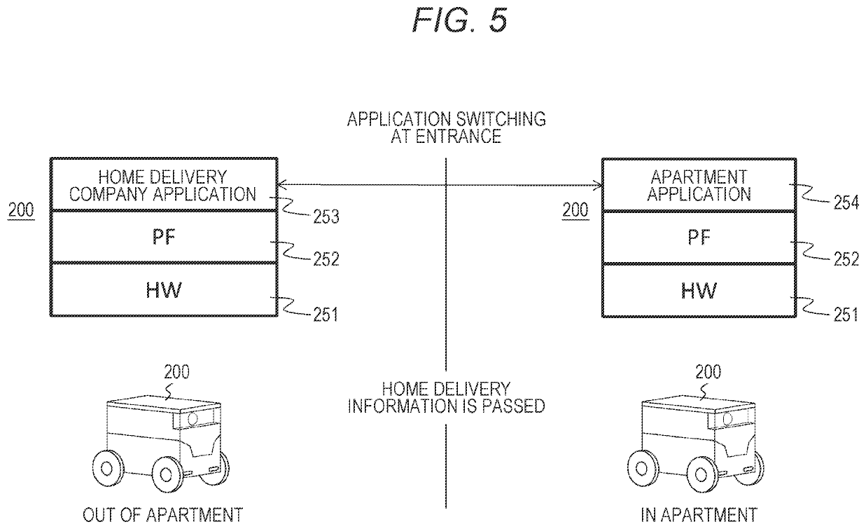

Returning to FIG. 1, the home delivery robot 200 in which packages are accommodated in the accommodation space autonomously travels on the basis of the map information, and arrives at an entrance 310 of the apartment 300 (see a position D2). As illustrated in FIG. 5, the home delivery robot 200 moves outside the apartment 300 on the basis of a home delivery company application (first application) 253. Here, the home delivery robot 200 includes hardware (HW) 251, and a platform 252, which is a piece of software that provides an environment in which an application works, and the home delivery company application 253 works on this platform 252.

When the home delivery robot 200 arrives at the entrance 310 of the apartment 300 from outside the apartment 300, the home delivery company application 253 is switched to an apartment application (second application) 254. Thereafter, the home delivery robot 200 enters the apartment 300 (see a position D3). As illustrated in FIG. 5, the home delivery robot 200 moves in the apartment 300 on the basis of the apartment application 254.

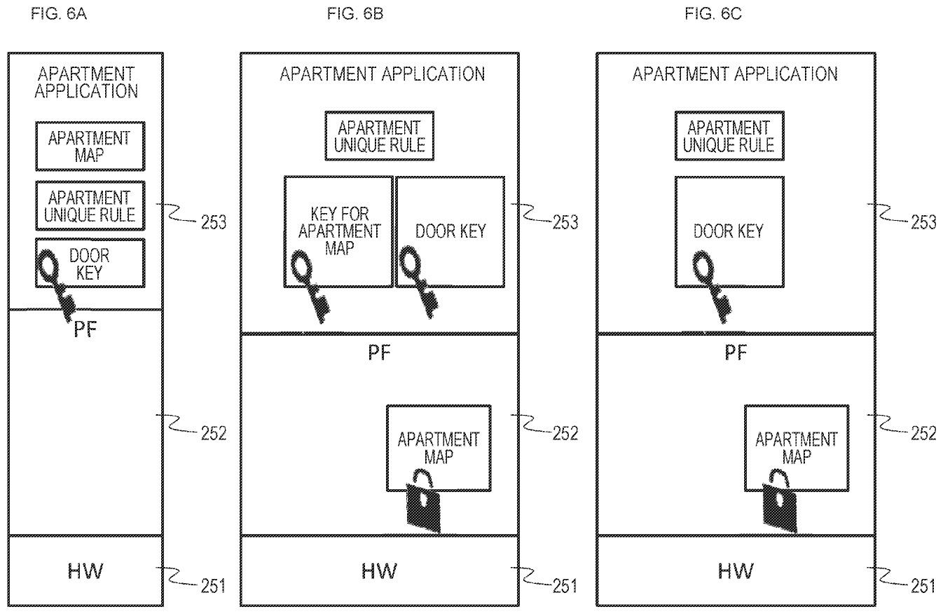

The apartment application 254 includes door key information for entering the apartment 300, map information on the apartment 300, and unique rule information on the apartment 300 (see FIG. 6(a)). Note that it is also conceivable that the encrypted map information on the apartment 300 is stored in advance on the platform 252, and the apartment application 254 includes key information for decrypting the encrypted map information (see FIG. 6(b)). Furthermore, it is also conceivable that the door key information for entering the apartment 300 also serves as the key information for decrypting the encrypted map information (see FIG. 6(c)). In addition, in some cases, there is no apartment unique rule.

The home delivery robot 200 can enter the apartment 300 by opening an entrance door of the apartment 300 using the key information for entering the apartment 300 included in the apartment application 254. For example, the home delivery robot 200 presents a key to a camera on a security door of the apartment 300 with a quick response (QR) code to obtain the key in exchange. Furthermore, for example, the home delivery robot 200 obtains the key in exchange when making a touch by near field communication (NFC). In addition, for example, the home delivery robot 200 obtains the key in exchange by communication by Bluetooth or the like. Note that “QR code” is a registered trademark.

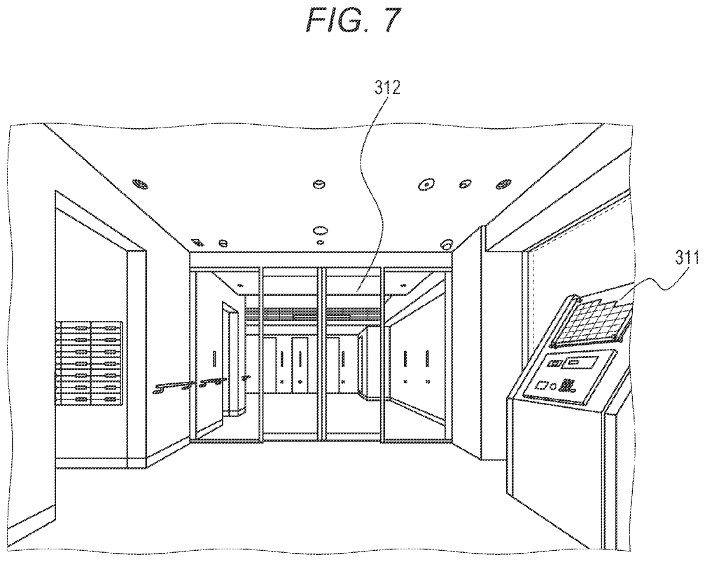

FIG. 7 illustrates an example of the entrance of the apartment 300. Normally, the occupant of the apartment 300 is allowed to open an entrance door 312 by performing a release operation (such as inserting a room key or placing a card key above) on an auto-lock release operation unit 311 installed at the entrance. The home delivery robot 200 is allowed to open the entrance door 312 by obtaining the key in exchange by any of the above-mentioned methods on the auto-lock release operation unit 311, for example.

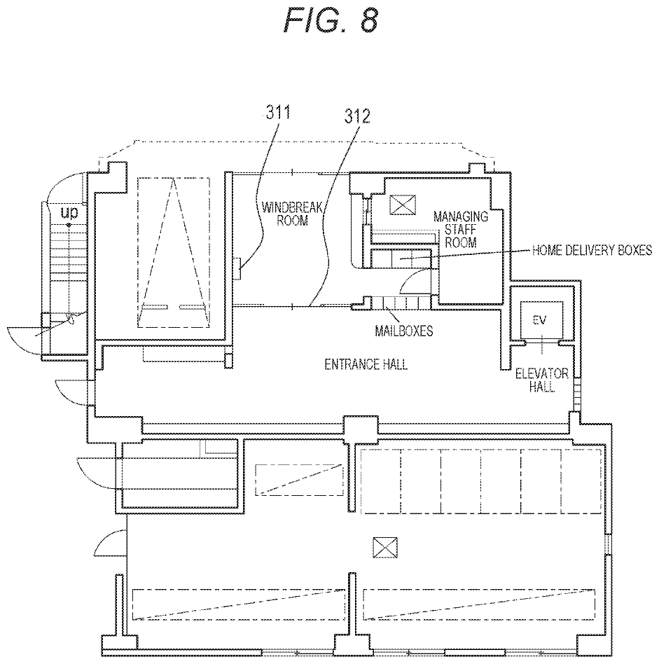

FIG. 8 illustrates an example of the map information on the apartment 300. This example illustrates, for example, a cross-sectional view of the first floor where the entrance of the apartment is located. Note that, although illustration is omitted, the map information on the apartment 300 includes, for example, the cross-sectional view of each floor on the second floor and above.

The unique rule information on the apartment 300 includes, for example, the following information.

(1) Information on the position of a dedicated elevator

(2) Information on priorities (for elevators and passages) with respect to residents

(3) Information on rule changes depending on the time of day (morning, evening, and the like)

(4) Individual circumstances (a detour of a place where there are many children and a dwelling unit of a resident who has many complaints, and the like)

When switching the application from the home delivery company application 253 to the apartment application 254, the home delivery robot 200 passes predetermined information, in this embodiment, home delivery information (before delivery), from the home delivery company application 253 to the apartment application 254. This home delivery information (before delivery) is passed via the shared area.

The home delivery information (before delivery) includes, for example, the following information (home delivery instruction information).

(1) Home delivery address, recipient, desired time of receipt

(2) Recipient assigned or not assigned

(3) Receipt sign required or not required

(4) Package to be shipped or not to be shipped

(5) Payment for delivery to be made or not to be made

(6) Cash on delivery is to be paid or not to be paid

(7) Process when absent
Bringing back
Held in apartment (manager's room)

(8) Handling precautions applied or not applied

(9) Contents, weight, size,

Returning to FIG. 1, the home delivery robot 200 conducts a series of processes on the basis of the map information on the apartment 300, the unique rule information on the apartment 300, and the home delivery information (before delivery), including autonomously traveling to reach a delivery destination dwelling unit 320, and handing a package to a recipient (see a position D4). After these processes are ended, the home delivery robot 200 returns to the entrance 310 of the apartment 300 (see the position D3) to switch the application from the apartment application 254 to the home delivery company application 253, and goes out of the apartment 300 (see the position D2) to return to the parking position of the home delivery truck 100 by autonomously traveling (see the position D1).

When switching the application from the apartment application 254 to the home delivery company application 253, the home delivery robot 200 passes predetermined information, in this embodiment, home delivery information (after delivery), from the apartment application 254 to the home delivery company application 253. This home delivery information (after delivery) is passed via the shared area.

The home delivery information (after delivery) includes, for example, the following information (home delivery end report information).

(1) Receipt information
Absence
   Redelivery, home delivery box, custody in manager's room
Receipt
   Recipient, receipt sign
   Cash on delivery, payment for delivery (by cash, credit, or the like)
Message
   Message from the home delivery company

(2) Shipping package
To be shipped, contents, weight, size, payment for delivery

(3) Satisfaction level/statement of criticism or dissatisfaction
Facial expressions, actual voices, questionnaires

(4) Time from entering the premises of the apartment to delivery

(5) Home delivery order in a case where there is a plurality of packages

Note that it is also conceivable to add a part (for example, the home delivery address and recipient) or all of the home delivery information (before delivery) to this home delivery information (after delivery) in order to associate the home delivery information (after delivery) with the home delivery information (before delivery).

The home delivery robot 200 downloads (receives) the apartment application from a cloud (a server connected via a computer network such as the Internet) to use when switching the application from the home delivery company application 253 to the apartment application 254. At this time, it is conceivable that the home delivery robot 200 deletes the home delivery company application 253, but in a case where there is a sufficient memory region, it is also conceivable to keep the home delivery company application 253 in a sleep state (a state in which the function is stopped) instead of deleting the home delivery company application 253.

Furthermore, the home delivery robot 200 downloads (receives) the home delivery company application 253 from a cloud to use when switching the application from the apartment application 254 to the home delivery company application 253. Note that, as described above, when switching the application from the home delivery company application 253 to the apartment application 254, in a case where the home delivery company application 253 is kept instead of being deleted, the download is not required. At this time, the home delivery robot 200 deletes the home delivery company application 253. With this procedure, information on the apartment 300 can be prevented from leaking to the outside.

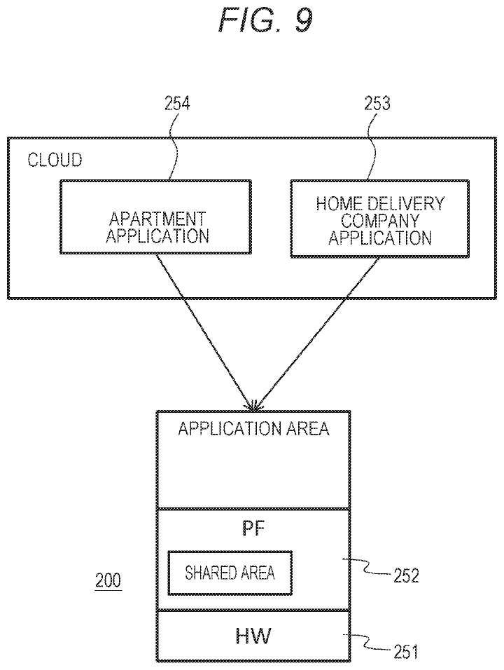

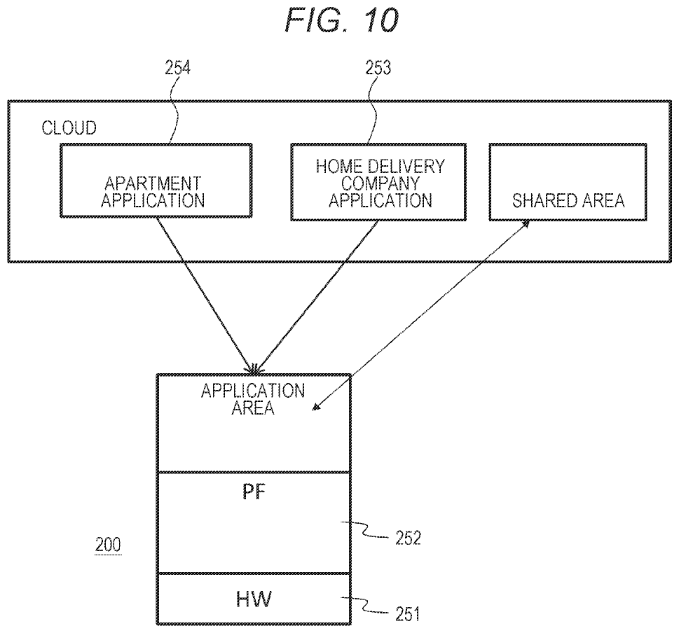

FIG. 9 illustrates that the home delivery robot 200 downloads the apartment application 254 and the home delivery company application 253 from a cloud. In this example, the platform 252 contains the shared area for passing the home delivery information between applications. FIG. 10 also illustrates that the home delivery robot 200 downloads the apartment application 254 and the home delivery company application 253 from a cloud. In this example, the cloud contains the shared area for passing the home delivery information between applications.

The application switching will be further described. The application is switched by, for example, a process by the platform 252. This switching is performed, for example, at the timing of (1) or (2) below.

(1) Timing of acquisition of information prepared at the entrance of the apartment

(2) Application switching timing associated with the map information

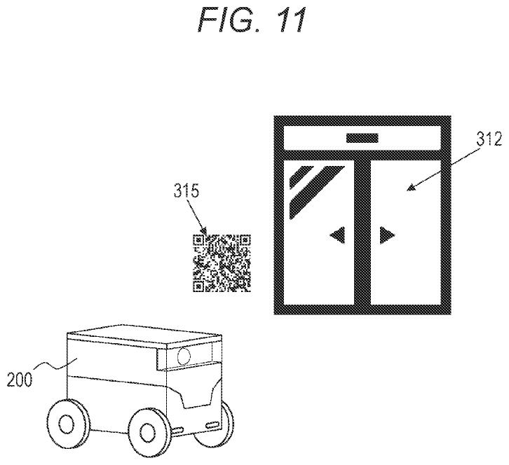

First, a case where the application is switched at the timing of acquisition of information prepared at the entrance (an exit when leaving) of the apartment will be described. When entering the apartment 300, the home delivery robot 200 reads a QR code 315 present near the entrance door 312 of the apartment 300 with a camera to acquire the uniform resource locator (URL) for downloading the apartment application 254 from the cloud, for example, as illustrated in FIG. 11, and downloads the apartment application 254 from the cloud on the basis of the acquired URL to switch the home delivery company application 253 to the apartment application 254.

Furthermore, similarly, when leaving the apartment 300, the home delivery robot 200 reads the QR code 315 present near the entrance door 312 with the camera to acquire the URL for downloading the home delivery company application 253 from the cloud, and downloads the home delivery company application 253 from the cloud on the basis of the acquired URL to switch the apartment application 254 to the home delivery company application 253.

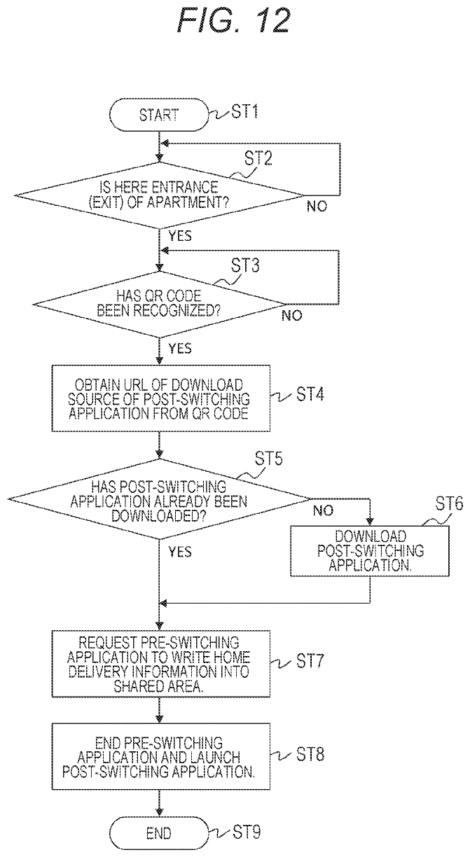

The flowchart in FIG. 12 illustrates an example of an application switching process procedure on the platform 252 of the home delivery robot 200. First, the platform 252 starts the process in step ST1. Then, in step ST2, the platform 252 verifies, on the basis of the map information, whether or not here is the entrance 310 of the apartment 300. In this case, the map information outside the apartment 300 is referred to when the apartment 300 is entered, and conversely, the map information on the apartment 300 is referred to when the apartment 300 is left.

When here is the entrance of the apartment 300, the platform 252 verifies in step ST3 whether or not the QR code arranged at the entrance 310 of the apartment 300 has been recognized. Then, when the QR code has been recognized, the platform 252 obtains the URL of the download source of a post-switching application from the QR code in step ST4. Here, the post-switching application is the apartment application 254 when the apartment 300 is entered, and is the home delivery company application 253 when the apartment 300 is left.

Next, the platform 252 verifies in step ST5 whether or not the post-switching application has already been downloaded. For example, in a case where the home delivery company application 253 is kept instead of being deleted when switching to the apartment application 254 is performed when the apartment 300 is entered, it is verified that the download has been finished, at this verification when the apartment 300 is left.

When the post-switching application has not yet been downloaded, the platform 252 downloads the post-switching application from the cloud in step ST6 on the basis of the URL acquired in step ST4. The plot form 252 proceeds to the process in step ST7 after the process in step ST6. When the download has been finished in step ST5. The platform 252 immediately proceeds to the process in step ST7.

In this step ST7, the platform 252 requests a pre-switching application to write the home delivery information into the shared area. Here, the home delivery information is the home delivery information (before home delivery) when the apartment 300 is entered, and is the home delivery information (after home delivery) when the apartment 300 is left.

Next, in step ST8, the platform 252 ends the pre-switching application and launches the post-switching application. The post-switching application launched in this manner reads out and uses the home delivery information written in the shared area.

Note that, when entering the apartment 300, the platform 252 deletes or keeps the ended pre-switching application, that is, the home delivery company application 253, in a state in which its function is stopped, but when leaving the apartment 300, always deletes the ended pre-switching application, that is, the apartment application 254, to surely prevent information on the apartment 300 from leaking to the outside.

After the process in step ST8, the platform 252 ends a series of application switching processes in step ST9.

Note that, in the above, the example of reading the QR code 315 present near the entrance door 312 with the camera and acquiring the URL for downloading the post-switching application has been indicated, but the URL may be acquired by making a touch with NFC, or the URL may be acquired by performing communication by Bluetooth or the like.

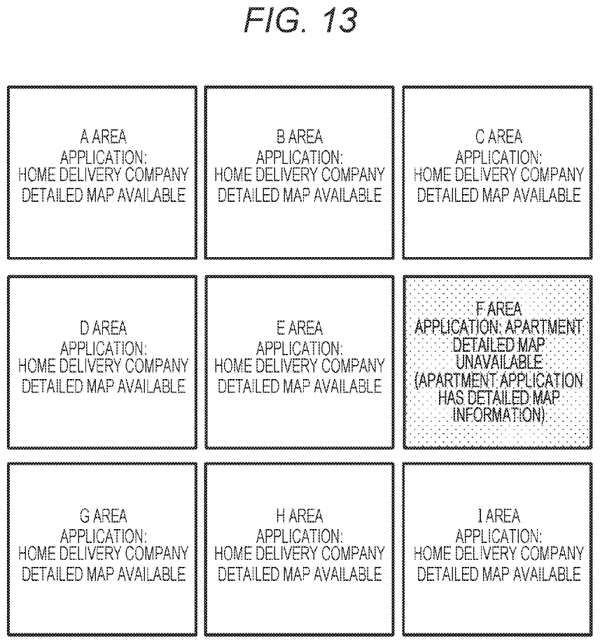

Next, a case where the application switching is performed at the application switching timing associated with the map information will be described. The home delivery robot 200 autonomously travels from the parking position of the delivery truck 100 toward the apartment 300 on the basis of general map information. This general map information is included, for example, in the home delivery company application. FIG. 13 illustrates an example of the general map information.

In this map information, areas from an A area to an I area are each divided in a grid shape to simplify the drawing. Except for the F area, the general map information contains a detailed map, and the home delivery robot 200 makes actions according to the home delivery company application. The home delivery robot 200 can recognize, from the general map information, that the F area corresponds to the apartment 300 to recognize that there is no detailed map of the apartment 300 and that it is necessary to make actions in the apartment 300 according to the apartment application, and additionally can acquire the URL for downloading the apartment application 254 from the cloud.

When coming closer to the apartment 300 in the F area to some extent, the home delivery robot 200 downloads the apartment application 254 from the cloud on the basis of the URL obtained from the general map information, and switches the home delivery company application 253 to the apartment application 254 at the entrance of the apartment 300 in the F area. Furthermore, similarly, when leaving the apartment 300, the home delivery robot 200 acquires the URL for downloading the home delivery company application 253 from the cloud, for example, from the map information included in the apartment application 254 when coming closer to the entrance of the apartment 300 to some extent, and downloads the home delivery company application 253 from the cloud on the basis of the acquired URL to switch the apartment application 254 to the home delivery company application 253 at the entrance of the apartment 300.

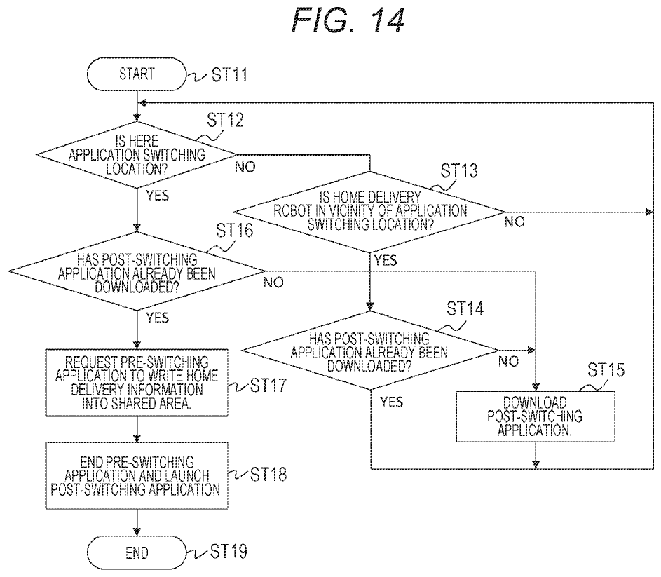

The flowchart in FIG. 14 illustrates an example of the application switching process procedure on the platform 252 of the home delivery robot 200. First, the platform 252 starts the process in step ST11. Then, in step ST12, the platform 252 determines, on the basis of the map information, whether or not here is an application switching location (the entrance of the apartment 300).

When here is not the application switching location, the platform 252 determines in step ST13 whether or not to be in the vicinity of the application switching location, on the basis of the map information. Here, the map information is the general map information included in the home delivery company application when the apartment 300 is entered, and is the map information inside the apartment 300 when the apartment 300 is left.

When not being in the vicinity of the application switching location, the platform 252 returns to the process in step ST12. When being in the vicinity of the application switching location, the platform 252 determines in step ST14 whether or not the post-switching application has already been downloaded. Here, the post-switching application is the apartment application 254 when the apartment 300 is entered, and is the home delivery company application 253 when the apartment 300 is left. For example, in a case where the home delivery company application 253 is kept instead of being deleted when switching to the apartment application 254 is performed when the apartment 300 is entered, it is verified that the download has been finished, at this verification when the apartment 300 is left.

When the post-switching application has not yet been downloaded, the platform 252 downloads the post-switching application from the cloud in step ST15 on the basis of the URL acquired from the map information. The plot form 252 returns to the process in step ST12 after the process in step ST15. When the download has been finished in step ST14. The platform 252 immediately returns to the process in step ST12.

When here is the application switching location in step ST12, the platform 252 determines in step ST16 whether or not the post-switching application has already been downloaded. When the download has not been finished, the platform 252 downloads the post-switching application from the cloud in step ST15 on the basis of the URL acquired from the map information, and thereafter returns to the process in step ST12.

When the post-switching application has already been downloaded in step ST16, the platform 252 requests the pre-switching application to write the home delivery information into the shared area in step ST17. Here, the home delivery information is the home delivery information (before home delivery) when the apartment 300 is entered, and is the home delivery information (after home delivery) when the apartment 300 is left.

Next, in step ST18, the platform 252 ends the pre-switching application and launches the post-switching application. The post-switching application launched in this manner reads out and uses the home delivery information written in the shared area.

Note that, when entering the apartment 300, the platform 252 deletes or keeps the ended pre-switching application, that is, the home delivery company application 253, in a state in which its function is stopped, but when leaving the apartment 300, always deletes the ended pre-switching application, that is, the apartment application 254, to surely prevent information on the apartment 300 from leaking to the outside.

After the process in step ST18, the platform 252 ends a series of application switching processes in step ST19.

As described above, in the home delivery system 10 illustrated in FIG. 1, when entering the apartment 300, the home delivery robot 200 switches the home delivery company application 253 to the apartment application 254 including the map information on the apartment 300, the unique rule information on the apartment 300, and the like. For this reason, the home delivery robot 200 can move satisfactorily after going into the apartment 300, and can easily and accurately deliver the package to the delivery destination dwelling unit 320 in the apartment 300.

Furthermore, in the home delivery system 10 illustrated in FIG. 1, when leaving the apartment 300, the home delivery robot 200 switches the apartment application 254 to the home delivery company application 253, and deletes the apartment application 254. Therefore, information on the apartment 300 can be surely prevented from leaking to the outside.

Note that the effects described in the present description merely serve as examples and not construed to be limited. There may be another effect as well.

### 2. Modifications

Note that, in the above-described embodiment, an example in which the specific region is the apartment 300 has been described. However, in the present technology, the specific region is not limited to the apartment, and may be another private space. For example, even if the apartment is replaced with a room in the apartment, a room in a hotel, or the like, a similar technique can prevent information from leaking to the outside and protect the privacy.

Furthermore, in the above-described embodiment, an example in which the moving body is the home delivery robot 200 has been indicated. However, in the present technology, the moving body is not limited to the home delivery robot. For example, the moving body may be a cleaning robot that cleans the premises of the apartment or a specific dwelling unit in the apartment, or a sales robot that sell a predetermined product at a specific position in the apartment or by visiting each dwelling unit in the apartment, or the like.

In addition, the favorable embodiments of the present disclosure have been described in detail with reference to the accompanying drawings. However, the technological scope of the present disclosure is not limited to these examples. It is clear that a person with average knowledge on the technological field of the present disclosure can arrive at various variations or alterations within the range of the technological spirit disclosed in the claims and as a matter of course, these variations or alterations are comprehended as part of the technological scope of the present disclosure.

Furthermore, the present technology can be also configured as described below.

(1) A moving body including:

a sensor that recognizes an outer world;

an autonomous traveling unit that autonomously travels using information from the sensor; and

an information acquisition unit that acquires information regarding a specific region, in which

the autonomous traveling unit autonomously travels in the specific region on the basis of the information regarding the specific region.

(2) The moving body according to (1) above, further including:

an information storage unit that stores information; and

an application switching control unit that switches an application stored in the information storage unit when entering the specific region from a first application for enabling autonomous traveling outside the specific region to a second application including the information regarding the specific region.

(3) The moving body according to (2) above, in which

the application switching control unit

controls such that, when switching the first application to the second application, predetermined information is passed from the first application to the second application.

(4) The moving body according to (3) above, in which

the predetermined information is passed from the first application to the second application via a shared area.

(5) The moving body according to (4) above, in which

a cloud contains the shared area.

(6) The moving body according to any one of (3) to (5) above, in which

the predetermined information includes information regarding home delivery.

(7) The moving body according to any one of (2) to (6) above, in which

the application switching control unit

switches the first application to the second application at a timing of acquisition of information prepared at an entrance of the specific region.

(8) The moving body according to any one of (2) to (6) above, in which

the application switching control unit

switches the first application to the second application at an application switching timing associated with map information.

(9) The moving body according to any one of (1) to (8) above, in which

the information acquisition unit

receives the information regarding the specific region from a cloud.

(10) The moving body according to any one of (1) to (9) above, in which

the information regarding the specific region includes map information on the specific region.

(11) The moving body according to any one of (1) to (10) above, in which

the information regarding the specific region includes unique rule information on the specific region.

(12) The moving body according to any one of (1) to (8) and (11) above, in which

the information regarding the specific region includes key information for decrypting encrypted map information on the specific region.

(13) The moving body according to any one of (1) to (12) above, in which

the information regarding the specific region includes key information for entering the specific region.

(14) The moving body according to any one of (1) to (13) above, further including

an information deletion unit that deletes the information regarding the specific region when leaving the specific region.

(15) The moving body according to any one of (1) to (14) above, in which

the sensor includes at least one of a camera, a time-of-flight (ToF) sensor, a light detection and ranging or laser imaging detection and ranging (LIDAR) sensor, a global positioning system (GPS) sensor, a magnetic sensor, or a radio wave intensity sensor.

(16) A control method for a moving body, the control method including,

in controlling the moving body including: a sensor that recognizes an outer world; and

an autonomous traveling unit that autonomously travels using information from the sensor,

controlling the autonomous traveling unit such that, in a specific region, the autonomous traveling unit autonomously travels on the basis of information regarding the specific region.

(17) A program for causing a computer to execute,

in controlling a moving body including: a sensor that recognizes an outer world; and

an autonomous traveling unit that autonomously travels using information from the sensor,

controlling the autonomous traveling unit such that, in a specific region, the autonomous traveling unit autonomously travels on the basis of information regarding the specific region.

(18) A moving body including:

a sensor that recognizes an outer world; and

an autonomous traveling unit that autonomously travels in a specific region on the basis of information from the sensor and information regarding the specific region; and

an information deletion unit that deletes the information regarding the specific region when leaving the specific region.

(19) The moving body according to (18) above, further including:

an information storage unit that stores information; and

an application switching control unit that switches an application stored in the information storage unit when leaving the specific region from a second application including the information regarding the specific region to a first application for enabling autonomous traveling outside the specific region.

(20) The moving body according to (19) above, in which

the application switching control unit

switches the second application to the first application at a timing of acquisition of information prepared at an entrance of the specific region.

(21) The moving body according to (19) above, in which

the application switching control unit

switches the second application to the first application at an application switching timing associated with map information.

### REFERENCE SIGNS LIST

10 Home delivery system
100 Home delivery truck
101 Side panel
102 Side door
103 Ladder rail
200 Home delivery robot (moving body)
201 Main body
202 Lid
210 Control unit
211 Signal processing circuit
212 CPU
213 DRAM
214 Flash ROM
215 PC card interface
216 Wireless communication unit
217 Internal bus
218 Battery
219 Camera
220 IMU
221 ToF sensor
222 Touch sensor
223 Microphone
224 Speaker
225 Display unit
226 Movable part
227 Actuator
228 Encoder (potentiometer)
251 Hardware (HW)
252 Platform (PF)
253 Home delivery company application
254 Apartment application
300 Apartment
310 Entrance
311 Auto-lock release operation unit
312 Entrance door
320 Delivery destination dwelling unit

1. A moving body comprising:
a sensor that recognizes an outer world;
an autonomous traveling unit that autonomously travels using information from the sensor; and
an information acquisition unit that acquires information regarding a specific region, wherein
the autonomous traveling unit autonomously travels in the specific region on a basis of the information regarding the specific region.

2. The moving body according to claim 1, further comprising:
an information storage unit that stores information; and
an application switching control unit that switches an application stored in the information storage unit when entering the specific region from a first application for enabling autonomous traveling outside the specific region to a second application including the information regarding the specific region.

3. The moving body according to claim 2, wherein
the application switching control unit
controls such that, when switching the first application to the second application, predetermined information is passed from the first application to the second application.

4. The moving body according to claim 3, wherein
the predetermined information is passed from the first application to the second application via a shared area.

5. The moving body according to claim 4, wherein
a cloud contains the shared area.

6. The moving body according to claim 3, wherein
the predetermined information includes information regarding home delivery.

7. The moving body according to claim 2, wherein
the application switching control unit
switches the first application to the second application at a timing of acquisition of information prepared at an entrance of the specific region.

8. The moving body according to claim 2, wherein
the application switching control unit
switches the first application to the second application at an application switching timing associated with map information.

9. The moving body according to claim 1, wherein
the information acquisition unit
receives the information regarding the specific region from a cloud.

10. The moving body according to claim 1, wherein
the information regarding the specific region includes map information on the specific region.

11. The moving body according to claim 1, wherein
the information regarding the specific region includes unique rule information on the specific region.

12. The moving body according to claim 1, wherein
the information regarding the specific region includes key information for decrypting encrypted map information on the specific region.

13. The moving body according to claim 1, wherein
the information regarding the specific region includes key information for entering the specific region.

14. The moving body according to claim 1, further comprising
an information deletion unit that deletes the information regarding the specific region when leaving the specific region.

15. The moving body according to claim 1, wherein
the sensor includes at least one of a camera, a time-of-flight (ToF) sensor, a light detection and ranging or laser imaging detection and ranging (LIDAR) sensor, a global positioning system (GPS) sensor, a magnetic sensor, or a radio wave intensity sensor.

16. A control method for a moving body, the control method comprising,
in controlling the moving body including: a sensor that recognizes an outer world; and
an autonomous traveling unit that autonomously travels using information from the sensor,
controlling the autonomous traveling unit such that, in the specific region, the autonomous traveling unit autonomously travels on a basis of information regarding the specific region.

17. A program for causing a computer to execute,
in controlling a moving body including: a sensor that recognizes an outer world; and
an autonomous traveling unit that autonomously travels using information from the sensor,
controlling the autonomous traveling unit such that, in the specific region, the autonomous traveling unit autonomously travels on a basis of information regarding the specific region.
